(19) United States
(12) Patent Application Publication
(10) Pub. No.: US 2017/0020362 A1
(43) Pub. Date: Jan. 26, 2017

(54) SYSTEM AND METHOD FOR CLEANING JEWELRY AND OTHER ITEMS

(71) Applicant: COLLE PRODUCTS, LLC, Mountain Lakes, NJ (US)

(72) Inventor: Thadine CLIFTON, Mountain Lakes, NJ (US)

(73) Assignee: COLLE PRODUCTS, LLC, Mountain Lakes, NJ (US)

(21) Appl. No.: 15/230,957

(22) Filed: Aug. 8, 2016

Related U.S. Application Data
(63) Continuation of application No. 13/814,850, filed on May 22, 2013, now abandoned.
(60) Provisional application No. 61/371,757, filed on Aug. 9, 2010.

(51) Int. Cl. A47L 25/00; A46B 9/02; B08B 3/00; B08B 1/00; B08B 3/04

(52) U.S. Cl. CPC A47L 25/00; B08B 1/002; B08B 3/04; B08B 3/003; A46B 9/02

(57) ABSTRACT

Disclosed herein are various cleaning systems based on the assemblage of a container, a nozzle, an actuator, and one or more releasable cover members configured to receive an item to be cleaned. Also disclosed is a method for cleaning an item based on the steps of obtaining one of the various cleaning systems, detaching a cover member from the assembly, placing the item in the cover member, dispensing cleaning product into the cover member and waiting a sufficient time for the cleaning product to clean the item. Further disclosed is a cleaning product based on a liquid carrier and a foaming product.

### FIELD OF INVENTION

The present invention relates to the use of or a method of using a product to clean jewelry and other items, and related systems and formulations.

### BACKGROUND

Cleaning jewelry is generally done by hand cleaning the jewelry with a liquid cleaner by soaking the jewelry, possibly brushing the jewelry to remove any adhered matter and subsequently rinsing the jewelry to remove any loosed material and excess cleaner. Alternately jewelry may be cleaned by bringing the jewelry to a commercial establishment that can use professional methods such as steam cleaning to clean the item. Hand cleaning can involve using a viscous liquid alone or in a volume of water either in a container of some sort. Difficult to clean soils on jewelry which is embedded in nooks or crevices are often difficult to remove by hand cleaning and cannot easily be removed by present in-home methods even when using brushes or other tools.

Foaming systems have been employed in specific types of cleaning and personal care compositions in the past. Also for liquid forms, for example, foaming agents have been incorporated into non-aqueous liquid detergent compositions. Further, foaming systems, or parts thereof, have been used in non-detergent (i.e., non-surfactant) carpet cleaning compositions. Further yet, foaming systems have been employed in contact lens cleaning compositions and other detergent compositions in the form of tablets. Still further yet, foaming systems have been employed in toothpastes, mouthwash (mouth rinse), dentifrice and cosmetics in various physical forms.

There exists a need to provide a method for using a cleaning composition to allow for a simplification of the traditional at-home hand jewelry cleaning process for cleaning strongly adhered soil, dirt or other matter and allow for flexibility for the user. Such a method preferably allows enough flexibility for the user to clean jewelry on an as-needed basis in the convenience of their home and have an ease of use.

### SUMMARY OF THE INVENTION

The present invention relates to the use of a foaming product comprising a foaming system, a surfactant system and optionally other components to clean a jewelry item. In one aspect the invention provides an aerosol spray that contains at least 50% (more preferably at least 90%) water, at least 0.6% surfactant/base, and a propellant.

The present invention therefore provides a method of cleaning comprising the steps of: (a) supplying a foaming cleaning product; (b) providing a container together with the cleaning product adapted to receive a piece of jewelry; (c) placing said piece of jewelry to said container (d) adding a foaming cleaning product to the container; (e) soaking the jewelry in contact with the foaming product until said foaming product has dissipated; (f) optionally rinsing the jewelry with water after the desired period of time.

### BRIEF DESCRIPTION OF THE DRAWINGS

FIG. 1 depicts a perspective view of the cleaning system according to the present invention.

FIG. 2 depicts a perspective view of separate elements of the cleaning system according to the present invention.

### DETAILED DESCRIPTION OF THE INVENTION

As used herein, the term “foaming” includes, but is not limited to, the formation of bubbles, foam, mousse, etc. from the foaming system as described herein.

As used herein, the term “jewelry” means any ornamental jewelry item such as, but not limited to: rings, earrings, necklaces, bracelets and other such items.

As used herein “soils” refers to the dirt, soils, oily substances on jewelry.

The present invention relates to the use of a foaming product comprising a foaming system surfactant system for cleaning jewelry.

The present invention relates to a method of cleaning having the steps of supplying a foaming cleaning product, providing a container together with the cleaning product adapted to receive a piece of jewelry, placing said piece of jewelry in said container, adding a foaming cleaning product to the container, soaking the jewelry in contact with the foaming product until said foaming product has dissipated, optionally rinsing the jewelry with water after the desired period of time

The present invention also relates to jewelry cleaning system kit including a container adapted to receiving at least one piece of jewelry, a foaming jewelry cleaner for spraying into said container and covering said at least one piece of jewelry and a brush for mechanically cleaning said at least one piece of jewelry.

The foaming product may preferably be in the form of a mousse which is contained within an aerosol can and sprayed by means of a pressure sensitive valve into a cleaning container.

### COMPONENTS OF THE FOAMING PRODUCT COMPOSITION

Liquid Carrier

The foaming product composition according to the present invention includes a liquid carrier as a primary solvent. The carrier fluid may be water, alcohol, or mixtures thereof. Where alcohols are used in the liquid carrier, preferred alcohols include isopropyl alcohol methanol, teat-butyl alcohol, and mixtures thereof. Water is considered to be a preferred carrier fluid in this formulation. The liquid carrier is present in a range from about 75% to about 98% of the composition, preferably in a range from about 85% to about 98% of the composition, and most preferably in a range from about 90% to about 97% of the composition.

Too much liquid carrier may result in spotting and/or unacceptably low viscosity; and too little liquid carrier could result in filming or in difficulty rinsing away the foaming product from the surface being cleaned.

The foaming product according to the present invention comprises a foam or mousse system. The foaming system results in a very fast bubble production.

Nonionic Surfactants

Nonionic surfactants may be broadly defined as compounds produced by the condensation of alkylene oxide groups with an organic hydrophobic material which may be aliphatic or alkyl aromatic in nature. The length of the hydrophilic or polyoxyalkylene radical which is condensed with any particular hydrophobic group can be readily adjusted to yield a water soluble compound having the desired degree of balance between hydrophilic and hydrophobic elements.

illustrative, but not limiting, examples of various suitable nonionic surfactant types are:

(a) polyoxyethylene or polyoxypropylene condensates of aliphatic carboxylic acids, whether linear or branched-chain and saturated or unsaturated, containing from about 8 to about 18 carbon atoms in the aliphatic chain and incorporating from about 5 to about 50 ethylene oxide and/or propylene oxide units. Suitable carboxylic acids include “coconut” fatty acids (derived from coconut oil) which contain an average of about 12 carbon atoms, “tallow” fatty acids (derived from tallow-class fats) which contain an average of about 18 carbon atoms, palmitic acid, myristic acid, stearic acid, and lactic acid.

(b) polyoxyethylene or polyoxypropylene condensates of aliphatic alcohols, whether linear or branched-chain and saturated or unsaturated, containing from about 6 to about 24 carbon atoms and incorporating from about 5 to about 50 ethylene oxide and/or propylene oxide units. Suitable alcohols include “coconut” fatty alcohol “tallow” fatty alcohol, lauryl alcohol, myristyl alcohol and oleyl alcohol.

(c) polyoxyethylene or polyoxypropylene condensates of alkyl phenols. These compounds include the condensation products of alkyl phenols having an alkyl group containing from about 6 to 12 carbon atoms in either a straight chain or branched configuration with ethylene and/or propylene oxide, the ethylene and/or propylene oxide being present as about 5 to 25 moles of ethylene and/or propylene oxide per mole of alkyl phenol. The alkyl substituent in such compounds can be derived, for example, from polymerized propylene, diisobutylene, and the like. Examples of compounds of this type include nonyl phenol condensed with about 9.5 moles of ethylene oxide per mole of phenol; dinonyl phenol condensed with about 12 moles of ethylene oxide per mole of phenol; dinonyl phenol condensed with about 15 moles of ethylene oxide per mole of phenol; and diisooctyl phenol condensed with about 15 moles of ethylene oxide per mole of phenol. Commercially available nonionic surfactants of this type include “IGEPAL CO-630”, marketed by the GAF Corporation of Wayne, N.J., and “TRITON X-45, X-114, X-100, and X-102”, all marketed by the Rohm and Haas Company of Philadelphia, Pa. Preferred nonionic surfactants in this category are water-soluble surfactants sold by Rohm and Haas Company under the trademark “TRITON”. TRITON X-100, which is an octylphenoxypolyethoxyethanol containing an average of 10 moles of ethylene oxide, is particularly preferred for use in the foaming product composition according to the present invention.

The above formulations may also contain an alcohol with less than six carbons (e.g. isopropanol and/or propylene glycol), a corrosion inhibitor (e.g. sodium nitrite or sodium benzoate), vinegar, a preservative (e.g. 4,4-dimethyloxazolidine-Bioban CS-1135), and/or a foam inhibitor.

Certain gaseous hydrocarbons (or mixtures thereof) can be used as the propellant. They typically liquefy under the pressure conditions of an aerosol can. For example, the propellant can be dimethylether, difluoroethane, propane, butane, isobutane and mixtures thereof (preferably isobutane alone). Alternatively, the propellant could be a non-hydrocarbon type of gas, such as CO2.

Base

Addition of a base to the foaming product composition may be used to raise the pH of the composition to a value from about 5 to about 11.5 in order to uncoil the polymeric molecules of the thickener and precipitate gelatinous thickening of the composition. Alternatively, ammonia may be used as a component of the foaming product composition to contribute to cleaning effectiveness. Adding a base may not be necessary if alcohol is present in the liquid carrier or if an organic acid is present in the foaming product composition because these components will also precipitate thickening of the mixture if used in sufficient quantity. Where used, sufficient base should be added to adjust the pH to the desired level of between about 5 and 11.5. Suitable bases include sodium hydroxide, ammonium hydroxide, morpholine, and amines such as, e.g., triethanolamine.

Cleaning System

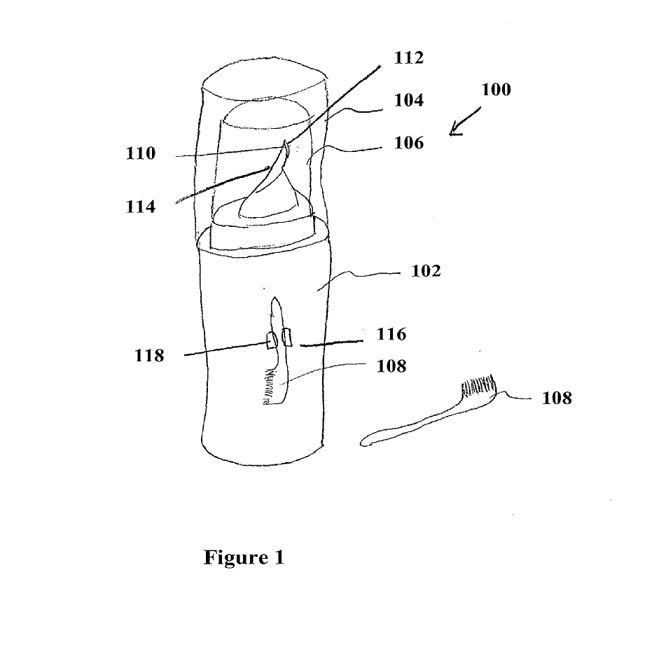

As shown in FIG. 1, the cleaning system provided in accordance with the present invention may be provided in a kit form. The kit may advantageously be provided such that the parts of the kit may serve the dual purposes of serving as part of the packaging and also providing a container for use during the cleaning process. Moreover, the cleaning system may therefore be a self-contained product that a user may easily acquire and utilize. The cleaning system kit 100 may include the cleaning product, and the structural elements of the cleaning system may comprise a cleaning product container, such as an aerosol can 102, a cover member/container 104 and 106, and a scouring member 108.

As can be seen by reference to FIG. 1, the cleaning kit is designated generally as 100, and comprises an aerosol can 102 for holding a cleaning product, and a cover member 104 and 106. As depicted, the cover member may comprise two separate cover members. As will be further explained, by providing two cover members the user may alternately select a different container for cleaning various sized jewelry. The aerosol can 102 is generally cylindrical in configuration, and dimensioned to receive the cover member. In addition the aerosol can 102 is provided with an elongated vertically disposed actuator 110 for dispensing cleaning product through a nozzle 112, the nozzle allows the cleaning product to be expelled from the interior of the aerosol can by applying pressure to the actuator, in a well recognized manner.

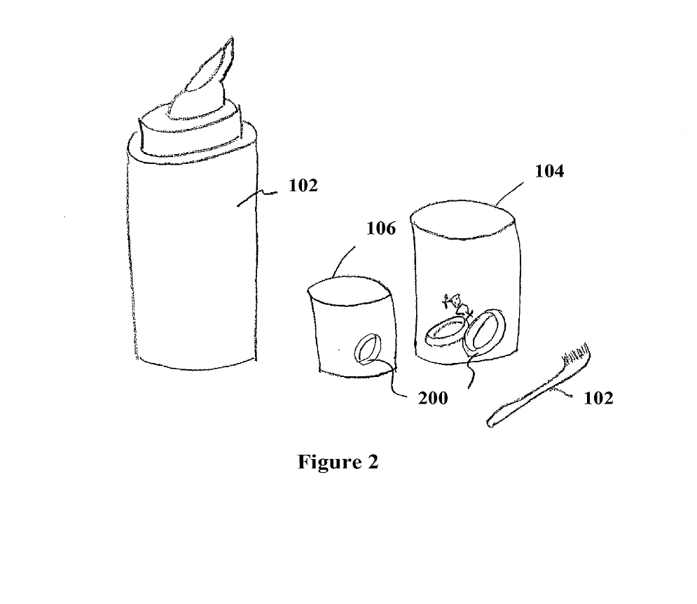

As can best be seen by reference to FIGS. 1 and 2 the actuator 110, that has been developed for use in conjunction with the aerosol can 102 and cover member 104/106 and comprises an elongated vertical component, that is dimensioned to allow a user to easily exert a force upon a valve actuating portion 114. The valve actuating portion 114 may be adapted to be operatively connected to a valve for controlling the dispensing of the cleaning product in one of a number of well recognized manners. The nozzle 112 is an open aperture that allows for the cleaning product to exit the aerosol can 102 under pressure once the valve is opened by the user depressing valve actuating portion 114 in a well recognized manner.

In the embodiment illustrated in FIGS. 1 and 2, the cover member 104/106 is formed to be received and releasably attached with aerosol can 102, by means of a resilient friction fit of the cover member/container to the aerosol can. The cover member/container may be cylindrical in shape and may typically have a volume which is in the range of about 1 ounce to 4 ounces. Additionally, the container may have dimensions such that a personal jewelry item may be accommodated therein. For example the container may have a dimension of anywhere from 1 to 3 inches in height and 1 to 3 or 4 inches in diameter. Since the cover member/container and the applicator are releasably joined, there is no possibility for the cleaning product to be expelled from the nozzle while the cover member is in place. In addition, because the cover member/container is releasably attached the user is assured of having the proper cleaning container available at any time that jewelry cleaning is required.

An additional structural feature that comprises this invention, consists of a brush or scouring member 108 that may be releasably attached to a portion of the device. FIG. 1 shows the brush 108 may releasably attached to the exterior wall 116 of the aerosol can. FIG. 1 shows the brush releasably secured in a resilient clip or fastener 118 on the exterior wall 116 of the aerosol can, although the present invention is not so limited. The brush may also for example be attached to alternate locations. For example the brush 108 may be attached to a retaining receptacle formed and recessed in the top of the cover (not shown).

The kit elements include an aerosol can 102 containing a cleaning product, containers 104 and 106 which may also serve as covers for the aerosol can and optionally a brush 108. The two separate containers provided, a large container 104 and a smaller container 106, may be used to clean different size jewelry items. The containers may be sized in accordance with the present invention to ensure that a sufficient amount of foaming cleaner is dispensed for various sized pieces of jewelry. In this way, the user may more easily measure the appropriate amount of cleaner depending on the size of the container and the piece of jewelry to be cleaned.

The cleaning product is a formulation as described above which when expelled from the aerosol can from a nozzle 112 by a user depressing an actuator 110 that actuates a valve within the nozzle. The expelled cleaning product forms mousse-like foam in the container. The cleaning product according to the present invention is a mousse or foam product. By utilizing a foam or mousse product the present invention more advantageously cleans jewelry by providing a cleaning system. The surfactant or detergents bind to the soil while mechanical energy or agitation is provided by the dissipation of the foam or mousse product. In this way the soil bound to the surfactant is pulled away from the jewelry and may easily be rinsed away in the final cleaning step.

It should be appreciated, that a device built in accordance with the above teachings would produce a self contained cleaning kit that would include all of the items normally required for jewelry cleaning. In addition, the problems associated with having an appropriate sized container for cleaning jewelry and dispensing the appropriate amount of cleaner to clean efficiently and effectively would also be eliminated, since the aerosol can and covers which serve as cleaning containers and adapted to be received and stored on top of the aerosol can insures that the containers and the cleaning product are stored together and that an appropriately sized container is provided for the user.

Cleaning Steps

The cleaning system according to the present invention may be used by removing one of the covers 104, 106 from the aerosol cleaning product can, which is then inverted into an upside-down position such that the open side is facing up. The user may then place at least one piece of jewelry 200 within the container. Alternately the user may use the provided brush 108 to loosen and or remove any adhered soil before placing the jewelry within the container. Once the jewelry is within the container, the user may then using the aerosol can introduce the foaming cleaner provided in accordance with the present invention into the container by depressing actuator 110. The user may introduce a sufficient amount of cleaner such that the foam reaches to about the top of the container rim. In this way the user can use one of the different sized containers 104 or 106 to dispense the appropriate amount of cleaner for the jewelry being cleaned. Once the container has been filled with the foam cleaner, the user then waits a sufficient amount of time for the foam to dissipate within the container. During the waiting time the action of the foaming cleaning product dissipating creates a mechanical abrading action on the surface of the jewelry by action of the bursting of the foam mousse.

Once the foam cleaning product has fully dissipated the user may then remove the jewelry and use the provided brush to loosen and or remove any adhered soil which was not removed by the action of the foaming cleaner. The user may then rinse the jewelry using simple tap water to remove any loosed soil and the remaining foaming cleaner. The user may then repeat the cleaning steps immediately or as needed in the future.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What we claim are:

1. A cleaning system, comprising:
a. a container configured to house a cleaning product;
b. a nozzle in communication with the container and configured to allow cleaning product to be expelled from the container;
c. an actuator operatively connected to the container and to the nozzle, and configured to dispense cleaning product through the nozzle when the cleaning system is in use; and
d. a first cover member releasably attached to the container and configured to receive an item to be cleaned with the cleaning system.

2. The cleaning system of claim 1, wherein the first cover member is further configured to house the nozzle.

3. The cleaning system of claim 1, wherein said container is an aerosol can.

4. The cleaning system of claim 1, wherein the actuator is configured to dispense cleaning product through the nozzle when pressure is applied to the actuator.

5. The cleaning system of claim 1, further comprising a valve configured to control the dispensing of the cleaning product.

6. The cleaning system of claim 5, further comprising a valve actuating portion operatively connected to the valve and dimensioned to allow a user of the cleaning system to exert a force upon the valve actuating portion.

7. The cleaning system of claim 1, further comprising a second cover member releasably attached to the container and configured to receive an item to be cleaned with the cleaning system.

8. The cleaning system of claim 7, wherein the second cover member is of a different size from the first cover member.

9. The cleaning system of claim 8, wherein the second cover member is further configured to house the first cover member.

10. The cleaning system of claim 7, wherein the first and second cover members are sized to ensure that a sufficient amount of cleaning product is dispensed in accordance with the size of the article received in the respective cover member.

11. The cleaning system of claim 1, wherein the cleaning system comprises at least one cover member configured to have a volume in the range of about 1 ounce to about 4 ounces.

12. The cleaning system of claim 1, wherein the cleaning system comprises at least one cover member configured to have a height dimension in the range of from about 1 to about 3 inches,

13. The cleaning system of claim 1, wherein the cleaning system comprises at least one cover member that is cylindrical in shape.

14. The cleaning system of claim 13, wherein the cylindrically shaped cover member is configured to have a diameter in the range of about 1 to about 4 inches.

15. The cleaning system of claim 1, further comprising a scouring member.

16. The cleaning system of claim 15, wherein the scouring member is a brush.

17. The cleaning system of claim 15, wherein the scouring member is releasably attached to a portion of the cleaning system.

18. The cleaning system of claim 1, further comprising a cleaning product.

19. The cleaning system of claim 18, wherein the cleaning product is a foaming cleaning product.

20. The cleaning system of claim 18, wherein the cleaning product comprises a nonionic surfactant.
